(19) United States
(12) Patent Application Publication
(10) Pub. No.: US 2020/0219000 A1
(43) Pub. Date: Jul. 9, 2020

(54) Data Processing Method And Apparatus

(71) Applicant: HUAWEI TECHNOLOGIES CO., LTD., Shenzhen (CN)

(72) Inventors: Feng WEN, Beijing (CN); Changliang XUE, Beijing (CN); Yuxin FU, Shenzhen (CN)

(21) Appl. No.: 16/825,694

(22) Filed: Mar. 20, 2020

Related U.S. Application Data
(63) Continuation of application No. PCT/CN2018/106910, filed on Sep. 21, 2018.

(30) Foreign Application Priority Data
Sep. 22, 2017 (CN) 201710868757.6

(51) Int. Cl. G06N 7/00; G06N 20/00; G05D 1/00

(52) U.S. Cl. CPC G06N 7/005; G05D 1/0088; G06N 20/00

(57) ABSTRACT

One example method includes obtaining a state vector set, where the state vector set includes at least one of a pose vector of an intelligent device or a landmark characteristic vector of an environment in which the intelligent device is located, determining a first linearized constraint equation, determining a first state vector, marginalizing the first state vector in the first linearized constraint equation to obtain a second linearized constraint equation, determining an objective function based on the second linearized constraint equation, and optimizing the at least one of the at least one pose vector or the at least one landmark characteristic vector based on the objective function to output a track of the intelligent device and a map of the environment in which the intelligent device is located.

### CROSS-REFERENCE TO RELATED APPLICATIONS

This application is a continuation of International Application No. PCT/CN2018/106910, filed on Sep. 21, 2018, which claims priority to Chinese Patent Application No. 201710868757.6, filed on Sep. 22, 2017. The disclosures of the aforementioned applications are hereby incorporated by reference in their entireties.

### TECHNICAL FIELD

This application relates to the field of artificial intelligence, and more specifically, to a data processing method and apparatus.

### BACKGROUND

A simultaneous localization and mapping (SLAM) technology is a key capability that a robot relies on to explore an unknown environment. In the absence of environmental prior information, the robot observes characteristics in an environment by using a sensor (for example, a camera or a laser) carried by the robot, and continuously models the environment in a moving process, to estimate system state vectors, namely, environmental characteristic positions and robot poses, and implement mapping and self-localization.

As the robot continuously moves in a scene and a motion scene continuously expands, both a quantity of environmental characteristic positions and a quantity of robot poses continuously increase, resulting in continuous increases in a calculation amount and memory overheads when solving is performed by using a filter or a nonlinear method. This greatly degrades real-time performance of a SLAM process, and even eventually causes a problem that a system cannot normally run.

Currently, a relatively commonly used method is a Schur complement based marginalization method. In a classical SLAM framework, state vectors, namely, robot poses and landmark characteristic points, optimized by a back end are continuously marginalized by using Schur complements, and a new objective function constructed by using marginalized state vectors is used as input for next optimization. However, according to the Schur complement based marginalization method, after the back end performs optimization, the back end needs to optimize all state vectors, and an information matrix needs to be inverted during marginalization of the state vectors. This results in relatively high overheads of calculation resources and calculation time.

Therefore, how to reduce overheads of calculation resources and calculation time in a SLAM state vector estimation process to improve running efficiency of the entire SLAM process has become a problem that urgently needs to be resolved.

### SUMMARY

This application provides a data processing method. A state vector is marginalized before optimization, to help reduce overheads of calculation resources and calculation time in a SLAM state vector estimation process, thereby improving running efficiency of an entire SLAM process and avoiding a system crash caused by a continuous increase in the state vector.

According to a first aspect, a data processing method is provided. The data processing method includes: obtaining a state vector set of an intelligent device, where the state vector set includes at least one pose vector of the intelligent device and/or at least one landmark characteristic vector of an environment in which the intelligent device is located, and the at least one pose vector and/or the at least one landmark characteristic vector are/is used to locate the intelligent device and map the environment in which the intelligent device is located; determining a first linearized constraint equation, where the first linearized constraint equation represents a linearized constraint relationship between the at least one pose vector and/or the at least one landmark characteristic vector; determining a first state vector, where the first state vector is a to-be-marginalized state vector in the state vector set; marginalizing the first state vector in the first linearized constraint equation to obtain a second linearized constraint equation, where the second linearized constraint equation represents a linearized constraint relationship of second state vectors, and the second state vector is a state vector other than the first state vector in the state vector set; determining an objective function for maximum likelihood estimation of the state vector based on the second linearized constraint equation; and optimizing the at least one pose vector and/or the at least one landmark characteristic vector based on the objective function, to output a track of the intelligent device and a map of the environment in which the intelligent device is located.

Therefore, according to the data processing method in this embodiment of this application, the state vector is marginalized before optimization, to help reduce overheads of calculation resources and calculation time in a SLAM state vector estimation process, thereby improving running efficiency of an entire SLAM process and avoiding a system crash caused by a continuous increase in the state vector.

In this embodiment of this application, at least some of the at least one pose vector may be selected as the to-be-marginalized state vector, or at least some of the at least one landmark characteristic vector may be selected as the to-be-marginalized state vector, or at least some of the at least one pose vector and at least some of the at least one landmark characteristic vector may be selected as to-be-marginalized state vectors.

With reference to the first aspect, in some implementations of the first aspect, the marginalizing the first state vector in the first linearized constraint equation to obtain a second linearized constraint equation includes: marginalizing the first state vector in the first linearized constraint equation based. on a null space of a Jacobian matrix of the first state vector, to obtain the second linearized constraint equation.

According to the data. processing method in this embodiment of this application, the state vector is marginalized based on the null space, and a non-key state vector is removed from state vectors without losing information, to avoid optimizing all the state vectors. This helps reduce the overheads of calculation resources and calculation time in the SLAM state vector estimation process, thereby improving the running efficiency of the entire SLAM process and avoiding the system crash caused by the continuous increase in the state vector.

With reference to the first aspect, in some implementations of the first aspect, the marginalizing the first state vector in the first linearized constraint equation based on a null space of a Jacobian matrix of the first state vector, to obtain the second linearized constraint equation includes: determining the Jacobian matrix of the first state vector; determining a left null space of the Jacobian matrix of the first state vector based on the Jacobian matrix of the first state vector; and left-multiplying the left null space of the Jacobian matrix of the first state vector by the first linearized constraint equation to obtain the second linearized constraint equation,

In some possible implementations, the left null space of the Jacobian matrix of the first state vector is determined by using the following formula:

Hₘ^{T}Uₘ=0, where

Hₘ is the Jacobian matrix of the first state vector, and Uₘ is the left null space of the Jacobian matrix of the first state vector.

In some possible implementations, the left null space of the Jacobian matrix of the first state vector is:

Uₘ=I−Hₘ(Hₘ^{T}Hₘ)⁻¹Hₘ^{T}, where

I is an identity matrix.

With reference to the first aspect, in some implementations of the first aspect, the second linearized constraint equation is:

Uₘ^{T}\tilde{z}≈Uₘ^{T}Hᵤ\tilde{x}ᵤ+Uₘ^{T}n, where

\tilde{x}ᵤ is an error vector of the second state vector, Hᵤ is a Jacobian matrix of the second state vector, U,ₘ is the null space of the Jacobian matrix of the first state vector, \tilde{z} is a residual vector of an observed vector, and n is a white Gaussian noise vector.

With reference to the first aspect, in some implementations of the first aspect, before the marginalizing the first state vector in the first linearized constraint equation to obtain a second linearized constraint equation, the method further includes: rearranging the first linearized constraint equation based on the first state vector, where the first state vector in the rearranged first linearized constraint equation is separated from the second state vector in the rearranged first linearized constraint equation.

With reference to the first aspect, in some implementations of the first aspect, the rearranged first linearized constraint equation is:

\tilde{z}≈Hᵤ\tilde{x}ᵤ+Hₘ\tilde{x}ₘ+n, where

\tilde{x}ᵤ is the error vector of the second state vector, \tilde{x}ₘ is an error vector of the first state vector, Hₘ is the Jacobian matrix of the first state vector, Hᵤ is the Jacobian matrix of the second state vector, \tilde{z} is the residual vector of the observed vector, and n is the white Gaussian noise vector.

With reference to the first aspect, in some implementations of the first aspect, the method further includes: determining an information matrix based on the objective function, where the information matrix is a constraint for next data processing.

In some possible implementations, the objective function is:

$${min}_{{\tilde{X}}_{u}} {‖ {z}^{′} - {H}_{u}^{′} {\tilde{x}}_{u} ‖}_{{R}^{- 1}}^{2} ,$$

where

z′=Uₘ^{T}\tilde{z}, H′ᵤ=Uₘ^{T}Hₙand R is a covariance of Uₘ^{T}n.

With reference to the first aspect, in some implementations of the first aspect, before the determining a first linearized constraint equation of the at least one pose vector and/or the at least one landmark characteristic vector, the method further includes: determining a nonlinearized constraint equation of the at least one pose vector and/or the at least one landmark characteristic vector; and linearizing the nonlinearized constraint equation based on a Jacobian matrix of the at least one pose vector and/or the at least one landmark characteristic vector, to obtain the first linearized constraint equation.

In some possible implementations, the nonlinearized constraint equation is linearized by using a Gauss-Newton method, to obtain the first linearized constraint equation.

In some possible implementations, the method further includes: determining an information matrix based on the objective function, where the information matrix is used to optimize and update the second state vector; and constructing a new constraint term based on an optimized and updated second state vector, where the constraint term is used to constrain a linearized constraint equation established during next data processing.

in some possible implementations, the information matrix is:

Σ=H′ᵤ^{T}R⁻¹H′ᵤwhere

Σ is the information matrix.

In some possible implementations, graph optimization is performed on the second state vector, the second state vector is updated as \hat{x}ᵤ^{⊕}=\tilde{x}ᵤ+\hat{x}ᵤ, and a prior constraint for next graph optimization is constructed based on the obtained information matrix, where the prior constraint is:

$${‖ {X}_{u} - \hat{{X}_{u}^{⊕}} ‖}_{{\sum }^{- 1}}^{2}$$

The prior constraint is added to an entire pose graph as a new constraint for next data processing, thereby improving optimization of the entire graph, where

\tilde{x}ᵤ is an error vector of a to-be-preserved state vector, \hat{x}ᵤ is a previous estimate of the to-be-preserved state vector, and \hat{x}ᵤ^{⊕} is an updated estimate of the to-be-preserved state vector. According to the data processing method in this embodiment of this application, the state vector is marginalized based on the null space before the objective function is optimized, and the non-key state vector is removed from the state vectors without losing information, to avoid optimizing all the state vectors. This helps reduce the overheads of calculation resources and calculation time in the SLAM state vector estimation process, thereby improving the running efficiency of the entire SLAM process and avoiding the system crash caused by the continuous increase in the state vector.

According to a second aspect, a data processing apparatus is provided. The data processing apparatus is configured to perform any one of the first aspect or the possible implementations of the first aspect. Specifically, the data processing apparatus may include units configured to perform the method according to any one of the first aspect or the possible implementations of the first aspect.

According to a third aspect, a data processing apparatus is provided. The data processing apparatus includes: a memory, a processor, and a communications interface. The memory is configured to store a computer program. The processor is configured to invoke the computer program from the memory and run the computer program, so that the data processing apparatus performs the method according to any one of the first aspect or the possible implementations of the first aspect.

Specifically, the processor is configured to:

obtain a state vector set of an intelligent device, where the state vector set includes at least one pose vector of the intelligent device and/or at least one landmark characteristic vector of an environment in which the intelligent device is located, and the at least one pose vector and/or the at least one landmark characteristic vector are/is used to locate the intelligent device and map the environment in which the intelligent device is located;

determine a first linearized constraint equation, where the first linearized constraint equation represents a linearized constraint relationship between the at least one pose vector and/or the at least one landmark characteristic vector;

determine a first state vector, where the first state vector is a to-be-marginalized state vector in the state vector set; marginalize the first state vector in the first linearized constraint equation to obtain a second linearized constraint equation, where the second linearized constraint equation represents a linearized constraint relationship of second state vectors, and the second state vector is a state vector other than the first state vector in the state vector set;

determine an objective function for maximum likelihood estimation of the state vector based on the second linearized constraint equation; and

optimize the at least one pose vector and/or the at least one landmark characteristic vector based on the objective function, to output a. track of the intelligent device and a map of the environment in which the intelligent device is located.

According to a fourth aspect, a computer program product is provided. The computer program product includes a computer program (which may also be referred to as code or an instruction), and when the computer program is run on a computer, the computer is enabled to perform the method according to any one of the first aspect or the possible implementations of the first aspect.

According to a fifth aspect, a computer readable storage medium is provided. The computer readable storage medium is configured to store a computer program. The computer program includes an instruction for performing the method according to any one of the first aspect or the possible implementations of the first aspect.

According to the embodiments of this application, the state vector is marginalized based on the null space before the objective function is optimized, and the non-key state vector is removed from the state vectors without losing information, to avoid optimizing all the state vectors. This helps reduce the overheads of calculation resources and calculation time in the SLAM state vector estimation process, thereby improving the running efficiency of the entire SLAM process and avoiding the system crash caused by the continuous increase in the state vector.

### BRIEF DESCRIPTION OF DRAWINGS

FIG. 1 is a schematic diagram of an application scenario of technical solutions according to embodiments of this application;

FIG. 2 is a schematic flowchart of a data processing method according to an embodiment of this application;

FIG. 3 is a schematic flowchart of a null-space based marginalization method according to an embodiment of this application;

FIG. 4 is another schematic flowchart of a data processing method according to an embodiment of this application;

FIG. 5 is another schematic flowchart of a null-space based marginalization method according to an embodiment of this application;

FIG. 6 is still another schematic flowchart of a data processing method according to an embodiment of this application;

FIG. 7 shows a comparison between a calculation process in a null-space based marginalization method according to an embodiment of this application and a calculation process in a Schur complement based marginalization method;

FIG. 8 is a schematic block diagram of a data processing apparatus according to an embodiment of this application; and

FIG. 9 is another schematic block diagram of a data processing apparatus

### DESCRIPTION OF EMBODIMENTS

The following describes the technical solutions in this application with reference to the accompanying drawings.

Before the technical solutions in the embodiments of this application are described, definitions of several terms are described first.

Null space: It is known that A is an m×n matrix. A null space, also referred to as a kernel (kernel), of A is a set of n-dimensional vectors defined by the following formula:

ker(A)=(x∈ [symbol] ⁿ:Ax=0)

In other words, the null space is a set of all solutions x of the linear equation Ax=0,

Jacobian matrix: A Jacobian matrix is a matrix including first-order partial derivatives that are arranged in a specific manner. It is assumed that there is a function group including m n-variable functions, yⱼ(x₁, x₂, . . . xₙ) (i=1, 2, . . . m), which is referred to as a function group. A first-order derivative is calculated for the function group, to obtain the following Jacobian matrix:

$$J = {[ \begin{matrix}\frac{\partial {y}_{1}}{\partial {x}_{1}} & \frac{\partial {y}_{1}}{\partial {x}_{2}} & … & \frac{\partial {y}_{1}}{\partial {x}_{n}} \\ \frac{\partial {y}_{2}}{\partial {x}_{1}} & \frac{\partial {y}_{2}}{\partial {x}_{2}} & … & \frac{\partial {y}_{2}}{\partial {x}_{n}} \\ ⋮ & ⋮ & & ⋮ \\ \frac{\partial {y}_{m}}{\partial {x}_{1}} & \frac{\partial {y}_{m}}{\partial {x}_{2}} & … & \frac{\partial {y}_{m}}{\partial {x}_{n}}\end{matrix} ]}_{m \times n}$$

The embodiments of this application are applicable to the field of simultaneous localization and mapping (SLAM) and any intelligent device (Intelligent Equipment) used for state vector marginalization in a nonlinear estimation problem.

It should be understood that an intelligent device is any device, instrument, or machine that has a calculation processing capability. An intelligent device in the embodiments of this application may be a robot (Robot), an autonomous vehicle (Autonomous Vehicle), an unmanned aerial vehicle (Unmanned Aerial Vehicle), a smart household (Smart Home), a mobile phone terminal, or the like. This application does not impose any limitation on the intelligent device.

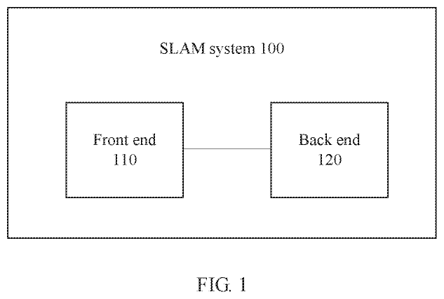

FIG. 1 is a schematic diagram of an application scenario of the technical solutions in the embodiments of this application. As shown in FIG. 1, the technical solutions in the embodiments of this application are applicable to a SLAM system 100 of a robot, The SLAM system 100 includes a front end (Front-end) 110 and a back end (Back-end) 120. The front end 110 is mainly for implementing data acquisition of a sensor and data association, and a main function of the back end 120 is to perform parameter estimation and optimization on a model generated by the front end. The following describes the technical solutions in the embodiments of this application by using the robot as an example.

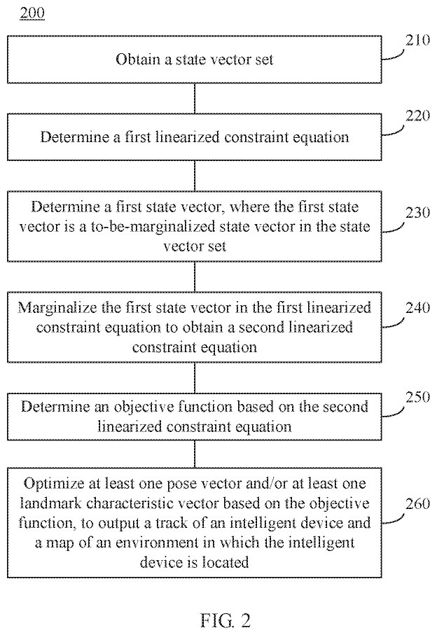

FIG. 2 is a schematic flowchart of a data processing method 200 according to an embodiment of this application. As shown in FIG. 2, the method 200 may be performed by the SLAM system 100 in FIG. 1, and the method 200 includes the following steps.

S210: Obtain a state vector set of an intelligent device, where the state vector set includes at least one pose vector of the intelligent device and/or at least one landmark characteristic vector of an environment in which the intelligent device is located, and the at least one pose vector and/or the at least one landmark characteristic vector are/is used to locate the intelligent device and map the environment in which the intelligent device is located.

Specifically, the front end 110 in the SLAM system 100 of the robot obtains data from a visual sensor and an inertial sensor IMU, extracts at least one pose vector of the robot, performs time synchronization on an obtained image and obtained IMU data, extracts, from visual image information, at least one landmark characteristic vector of an environment in which the robot is located, and performs characteristic matching.

It should be understood that characteristic matching means determining which of image data obtained at two different times corresponds to a same landmark characteristic.

For example, the robot generates a track (x₁, x₂, . . . , xₖ) in a moving process. Because motion of the robot conforms to a specific kinematic model law, a motion equation of the robot is established based on the IMU data and a motion model, and the motion equation is:

xₖ=fₖ(xₖ₋₁, uₖ)+wₖ (1)

where uₖ is an observed value from a motion sensor such as an odometer or an inertial measurement unit (IMU), and wₖ is white Gaussian noise with a covariance Qₖ.

It should be understood that the visual sensor extracts the landmark characteristic vector, but the visual sensor can calculate a pose vector of the robot by using data of a previous frame and a current frame, and the inertial sensor extracts the pose vector of the robot.

For another example, there are many landmarks in a motion scene of the robot, and at each position in the moving process, the robot measures a specific landmark point by using a sensor, and obtains a corresponding observed value. Further, the robot detects and tracks a characteristic based on an observation model, and the foregoing extracted landmark characteristic vector, the observation model, and a pose obtained through optimization of the previous frame are used as prior information, to establish an observation equation of the robot:

zₖⱼ=hₖⱼ(xₖ, x_{fj})+vₖⱼ )2)

where Zₖⱼ is an observed value for a characteristic x_{fj} when the robot is in a pose xₖ , and vₖⱼ is white Gaussian noise with a covariance Rₖ.

It should be understood that in S210, the state vector set may be obtained by the front end 110 in the SLAM system 100 in FIG. 1.

It should be further understood that noise meets Gaussian distribution N(0, σ²), where 0 represents a mean, and σ² represents a variance. Qₖ is a variance of noise corresponding to a specific motion equation, and Rₖ is a variance of noise corresponding to a specific observation equation.

S220: Determine a first linearized constraint equation, where the first linearized constraint equation represents a linearized constraint relationship between the at least one pose vector and/or the at least one landmark characteristic vector.

Specifically, the at least one pose vector of the robot and/or the at least one landmark characteristic vector of the environment in which the robot is located are/is obtained in S210; the established motion equation (1) and the established observation equation (2) are nonlinearized equations of the at least one pose vector and/or the at least one landmark characteristic vector; and the nonlinearized equations are linearized based on a Jacobian matrix of the at least one pose vector and/or the at least one landmark characteristic vector.

It should be understood that constructing a linear constraint equation is mainly to convert a nonlinearized constraint representation of a state vector into a linearized mathematical expression to simplify a solving process.

It should be further understood that in S220, the first linearized constraint equation of the at least one pose vector and/or the at least one landmark characteristic vector may be determined by the back end 120 in the SLAM system 100.

Jacobian matrices Fₖ, Hₖⱼ, and H_{fj} of the motion equation (1) and the observation equation (2) in constraint equations are calculated respectively as follows:

$${F}_{k} = \frac{\partial {f}_{k}}{\partial {x}_{k}} , {H}_{kj} = \frac{\partial {h}_{kj}}{\partial {x}_{k}} , and {H}_{fj} = \frac{\partial {h}_{kj}}{\partial {x}_{fj}} \qquad ( 3 )$$

where Fₖ is a Jacobian matrix of a robot pose in a state k in the motion model, and Hₖⱼ and H_{fj} are respectively Jacobian matrices of a robot pose vector and a landmark characteristic vector in the state k in the observation equation.

The constraint equation is linearized based on the Jacobian matrix, to obtain the first linearized constraint equation:

linearized motion equation: \tilde{x}ₖ≈Fₖ₋₁\tilde{x}ₖ₋₁+Wₖ (4)

linearized observation equation: \tilde{z}ₖⱼ≈Hₖⱼ\tilde{x}ₖ+H_{fj}x_{fj}+vₖⱼ (5)

S230: Determine a first state vector, where the first state vector is a to-be-marginalized state vector in the state vector set.

Specifically, based on a current SLAM application scenario, one of the pose vector of the robot and the landmark characteristic vector may be selected as a specific to-be-marginalized state vector, or both of the pose vector and the landmark characteristic vector may be used as to-be-marginalized state vectors.

It should be understood that the linearized constraint equation is rearranged by using a determined to-be-optimized state vector, to prepare for a subsequent marginalization operation.

It should be further understood that in S230, the first state vector may be determined by the back end 120 in the SLAM system 100.

For example, a sliding window method may be used, to use a point in a window as an actually to-be-marginalized point, where the point is earlier than a current state point of the robot by a relatively long time. First, a size of a sliding window is set to D (which is executed only during system initialization), and a pose vector and all landmark characteristic vectors at a moment (k-D) that are observed in a current window are used as to-be-marginalized state vectors.

For another example, a parallax method may be used, to use a point with a relatively small observation parallax from a current state point of the robot, as an actually to-be-marginalized point.

It should be understood that actually, S220 and S230 are performed in no particular order. The first linearized constraint equation may be determined before the to-be-marginalized state vector is determined, or the to-be-marginalized state vector may be determined before the first linearized constraint equation is determined. This is not limited in this application.

S240: Marginalize the first state vector in the first linearized constraint equation to obtain a second linearized constraint equation, where the second linearized constraint equation represents a linearized constraint relationship of second state vectors, and the second state vector is a state vector other than the first state vector in the state vector set.

Optionally, before the marginalizing the first state vector in the first linearized constraint equation to obtain a second linearized constraint equation of a second state vector, the method further includes:

rearranging the first linearized constraint equation based on the first state vector, where the first state vector in the rearranged first linearized constraint equation is separated from the second state vector in the rearranged first linearized constraint equation.

For example, the pose vector and all the landmark characteristic vectors at the moment (k-D) that are observed in the current window are determined as the to-be-marginalized state vectors in S230. The linearized constraint equation established in step S220 is rearranged, and the to-be-marginalized state vectors are separated from other state vectors in the linearized constraint equation, to obtain the rearranged first linearized constraint equation (6):

$$[ \begin{matrix}0 \\ ⋮ \\ 0 \\ {\tilde{z}}_{k 1} \\ ⋮ \\ {\tilde{z}}_{kj}\end{matrix} ] = [ \begin{matrix}1 & - {F}_{k - 1} & 0 & 0 & … & 0 \\ 0 & 1 & - {F}_{k - 2} & 0 & … & 0 \\ ⋮ & ⋮ & ⋮ & ⋮ & … & ⋮ \\ 0 & 0 & 0 & 0 & … & 1 \\ {H}_{k 1} & 0 & 0 & 0 & … & 0 \\ ⋮ & ⋮ & ⋮ & ⋮ & … & ⋮ \\ {H}_{kj} & 0 & 0 & 0 & … & 0\end{matrix} ] [ \begin{matrix}{\tilde{X}}_{k} \\ {\tilde{X}}_{k - 1} \\ ⋮ \\ {\tilde{X}}_{k - D + 1}\end{matrix} ] + [ \begin{matrix}0 & 0 & … & 0 \\ ⋮ & ⋮ & … & ⋮ \\ - {F}_{k - D} & 0 & … & 0 \\ 0 & {H}_{f 1} & … & 0 \\ ⋮ & ⋮ & … & ⋮ \\ 0 & 0 & … & {H}_{fj}\end{matrix} ] [ \begin{matrix}{\tilde{X}}_{k - D} \\ {\tilde{X}}_{f 1} \\ ⋮ \\ {\tilde{X}}_{fj}\end{matrix} ] + [ \begin{matrix}- {W}_{k} \\ ⋮ \\ - {W}_{k - D} \\ {V}_{k 1} \\ ⋮ \\ {V}_{kj}\end{matrix} ] \qquad ( 6 )$$

The rearranged first linearized constraint equation is denoted as:

\tilde{z}≈Hᵤ\tilde{x}ᵤ+Hₘ\tilde{x}ₘ+n )7)

where \tilde{x}ᵤ is an error vector of a to-be-preserved state vector, Hᵤ is a Jacobian matrix of the to-be-preserved state vector, \tilde{x}ₘ is an error vector of a to-be-marginalized state vector, Hₘ is a Jacobian matrix of the to-be-marginalized state vector, \tilde{z} is a residual vector of an observed vector, and n is a white Gaussian noise vector.

It should be understood that there is a difference between the first state vector and an error vector of the first state vector, and there is also a difference between the second state vector and an error vector of the second state vector. Separation of \tilde{x}ᵤ from \tilde{x}ₘ in the rearranged first linearized constraint equation may also be understood as separation of the first state vector from the second state vector.

It should be further understood that in S240, the second linearized constraint equation may be determined by the back end 120 in the SLAM system 100.

In this embodiment of this application, to keep a SLAM state vector bounded, state vector data needs to be limited, to reduce calculation overheads and calculation time. Therefore, the state vector is marginalized before optimization, and a non-key state vector is removed in the state vector set, to avoid optimizing all the state vectors. The second linearized constraint equation of the second state vector is obtained by marginalizing the to-be-marginalized state vector in the first linearized constraint equation, so that only a required state vector is preserved in the second linearized constraint equation.

Optionally, the marginalizing the first state vector in the first linearized constraint equation to obtain a second linearized constraint equation of a second state vector includes:

marginalizing the first state vector in the first linearized constraint equation based on a null space of a Jacobian matrix of the first state vector, to obtain the second linearized constraint equation.

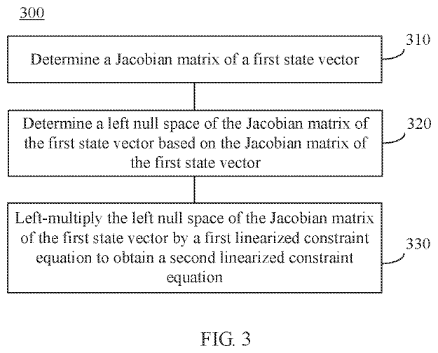

FIG. 3 is a schematic flowchart of a null-space based marginalization method 300 according to an embodiment of this application. As shown in FIG. 3, the null-space based marginalization method 300 may be performed by the back end 120 in the SLAM system in FIG. 1, and the method 300 includes the following steps.

S310: Determine the Jacobian matrix of the first state vector.

Specifically, Hₘ in the formula (7) is the Jacobian matrix of the to-be-marginalized state vector.

S320: Determine a left null space of the Jacobian matrix of the first state vector based on the Jacobian matrix of the first state vector.

Specifically, a left null space of the Jacobian matrix of the to-be-marginalized state vector is calculated, and a left null space Uₘ corresponding to Uₘ is solved based on the linearized constraint equation (7). A solving equation is:

Hₘ^{T}Uₘ=0 (8)

An analytical solution manner is provided to solve the left null space, and an analytical solution of Uₘ is expressed as:

Uₘ=I−Hₘ(Hₘ^{T}Hₘ)⁻¹Hₘ^{T} (9)

S330: Left-multiply the left null space of the Jacobian matrix of the first state vector by the first linearized constraint equation to obtain the second linearized constraint equation.

Specifically, the left null space Uₘ obtained through calculation is left-multiplied by the rearranged first linearized constraint equation, and an equation is as follows:

Uₘ^{T}\tilde{z}≈Uₘ^{T}Hᵤ\tilde{x}ᵤ+Uₘ^{T}Hₘ\tilde{x}ₘ+Uₘ^{T}n (10)

Hₘ^{T}Uₘ=0, and therefore, the finally obtained second linearized constraint equation is:

Uₘ^{T}\tilde{z}≈Uₘ^{T}Hᵤ\tilde{x}ᵤ+Uₘ^{T}n (11)

According to the null-space based marginalization method in this embodiment of this application, a non-key state vector is removed from state vectors based on the null space of the to-be-marginalized state vector, to help reduce calculation time.

S250: Determine an objective function for maximum likelihood estimation of the state vector based on the second linearized constraint equation.

It should be understood that maximum likelihood estimation (ML), also referred to as maximum probability estimation, is a theoretical point estimation method. A basic idea of the method is that after n sets of sample observed values are randomly extracted from a model, a most proper parameter estimator should make a probability of extracting the n sets of sample observed values from the model highest.

Specifically, based on the newly constructed second linearized constraint equation, the newly to-be-optimized objective function can be constructed for optimization performed by the back end 120 in the SLAM system 100. Specifically, the to-be-optimized objective function is constructed based on the reduced second linearized constraint equation that is newly constructed, to obtain:

$${min}_{{\tilde{X}}_{u}} {‖ {z}^{′} - {H}_{u}^{′} {\tilde{x}}_{u} ‖}_{{R}^{- 1}}^{2} \qquad ( 12 )$$

where z′=Uₘ^{T}\tilde{z}, H′ᵤ=Uₘ^{T}Hᵤ, and R is a covariance of Uₘ^{T}n.

Optionally, the data processing method 100 further includes:

Optionally, the method further includes:

determining an information matrix based on the objective function, where the information matrix is used to optimize and update the second state vector; and constructing a new constraint term based on the optimized and updated second state vector, where the constraint term is used to constrain a linearized constraint equation established during next data processing.

Specifically, after the formula (12) is obtained, a marginalized information matrix is calculated based on the formula (12), to obtain:

Σ=H′ᵤ^{T}R⁻¹H′ᵤ (13)

Specifically, based on the objective function, an optimal value of the second state vector is estimated by using a graph optimization method, and the information matrix is determined, where both the optimal value and the information matrix are used as constraints for next data processing.

S260: Optimize the at least one pose vector and/or the at least one landmark characteristic vector based on the objective function, to output a track of the intelligent device and a map of the environment in which the intelligent device is located.

Specifically, based on the reduced objective function, optimal estimation and optimization are performed on all state vectors (the pose vector of the robot and the landmark characteristic vector of the environment in which the robot is currently located) by using an extended Kalman filter (EKF) method or a nonlinear optimization method, to obtain a track of the robot and a map of the environment in which the robot is located. Graph optimization is performed on the second state vector, the second state vector is updated as \hat{x}ᵤ^{⊕}=\tilde{x}ᵤ+\hat{x}ᵤ, and a prior constraint for next graph optimization is constructed based on the obtained information matrix, where the prior constraint is:

$${‖ {X}_{u} - \hat{{X}_{u}^{⊕}} ‖}_{{\sum }^{- 1}}^{2} \qquad ( 14 )$$

The prior constraint is added to an entire pose graph as a new constraint for next optimization, thereby improving optimization of the entire graph, where

\tilde{x}ᵤ is an error vector of a to-be-preserved state vector, \hat{x}ᵤ is a previous estimate of the to-be-preserved state vector, and \hat{x}ᵤ^{⊕} is an updated estimate of the to-be-preserved state vector. According to the data processing method in this embodiment of this application, the state vector is marginalized based on the null space before the objective function is optimized, and the non-key state vector is removed from the state vectors without losing information, to avoid optimizing all the state vectors. This helps reduce overheads of calculation resources and calculation time in a SLAM state vector estimation process, thereby improving running efficiency of an entire SLAM process and avoiding a system crash caused by a continuous increase in the state vector.

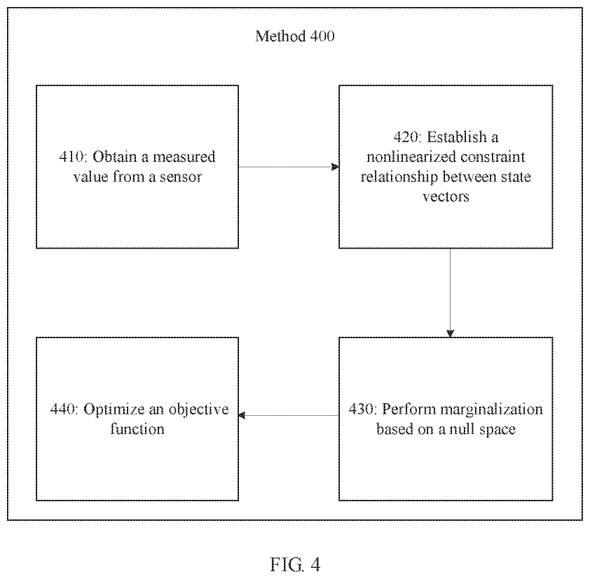

In a specific embodiment, FIG. 4 is a schematic flowchart of a data processing method 400 according to an embodiment of this application. As shown in FIG. 4, the method 400 includes the following steps.

S410: Obtain a measured value from a sensor.

Information is collected from sensors such as a camera and an IMU, image information in the camera is predicted, and data in the sensors such as the camera and the IMU is synchronized, to obtain an observed state vector of a current pose of an intelligent device.

S420: Establish a nonlinearized constraint relationship between state vectors.

A constraint relationship between sensor data of adjacent frames is established by using the foregoing motion equation (1) and observation equation (2), and a nonlinearized constraint relationship between all state vectors is further established through transfer of the constraint relationship.

S430: Perform marginalization based on a null space.

The nonlinearized constraint relationship between all the state vectors that is established in S420 is linearized, a non-key state vector is removed from the state vectors by using a left null space, and a to-be-optimized objective function is constructed based on a constraint of a to-be-preserved state vector.

S440: Optimize the objective function obtained through processing in S430.

Based on a reduced objective function, optimal estimation and optimization are performed on all state vectors by using an HU method or a nonlinear optimization method, to obtain a track and a map that are globally consistent.

It should be understood that S410 and S420 may be performed by the front end 110 in the SLAM system 100, and S430 and S440 may be performed by the back end 120 in the SLAM system 100.

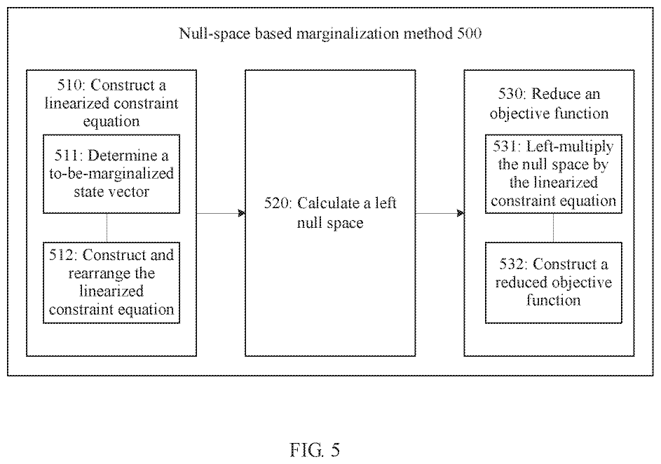

In another specific embodiment, FIG. 5 is a schematic flowchart of a null-space based marginalization method 500 according to an embodiment of this application. As shown in FIG. 5, the method 500 includes the following steps.

S510: Construct a linearized constraint equation.

Constructing a linear constraint equation is mainly to convert a nonlinearized constraint representation of a state vector into a linearized mathematical expression to simplify a solving process. In addition, the linearized constraint equation is rearranged by using a determined to-be-marginalized state vector, to prepare for a subsequent marginalization operation. This mainly includes the following two steps.

S511: Determine the to-be-marginalized state vector.

Based on an application scenario of a current SLAM process, whether to marginalize a pose vector of an intelligent device or a landmark characteristic vector of an environment in which the intelligent device is located is determined, and which pose vector or landmark characteristic vector is to be marginalized is also determined.

S512: Construct and rearrange the linearized constraint equation.

A Jacobian matrix of the state vector is calculated, the linearized constraint equation of the state vector is constructed by using the Jacobian matrix, and the linearized equation is rearranged based on the determined to-be-marginalized state vector.

S520: Calculate a left null space.

Calculating the left null space is mainly to complete a calculation operation on the left null space of a Jacobian matrix of the to-be-marginalized state vector.

S530: Reduce an objective function.

Reducing the objective function is mainly to left-multiply the left null space by the linearized equation to remove a non-key state vector from the linearized constraint equation, to obtain a marginalized linearized constraint equation, and a newly to-be-optimize objective function is constructed based on the marginalized linearized equation. This mainly includes the following two steps.

S531: Left-multiply the null space by the linearized constraint equation.

The null space of the Jacobian matrix of the to-be-marginalized state vector is left-multiplied by the linearized constraint equation to remove the non-key state vector from the linearized equation.

S532: Construct a reduced objective function.

After the non-key state vector is removed, a new constraint representation of a state vector is obtained, and the new to-be-optimize objective function is constructed based on the new constraint representation.

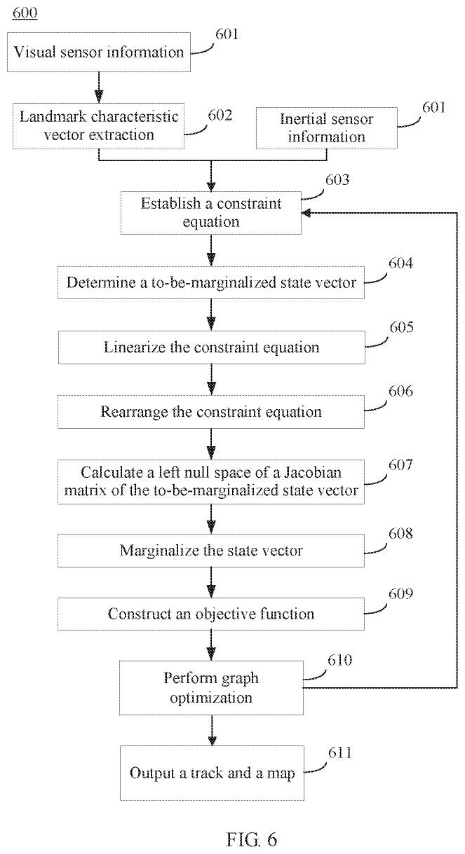

In a specific embodiment, FIG. 6 is a schematic flowchart of a data processing method 600 according to an embodiment of this application. As shown in FIG. 6, the method 600 includes the following steps.

S601: Obtain data from a visual sensor and an inertial sensor IMU, and perform time synchronization on an obtained image and obtained IMU data.

S602: Extract an environment landmark characteristic vector from visual image information, and perform characteristic matching.

S603: Establish a nonlinearized constraint equation of at least one pose vector and/or at least one landmark characteristic vector, where the constraint equation includes a motion equation and an observation equation; the motion equation of an intelligent device is established based on the IMU data in S601 and a motion model; and the observation equation is established based on the landmark characteristic vector extracted in S602, an observation model, and a pose obtained through optimization of a previous frame that are used as prior information.

S604: Determine a to-be-marginalized state vector, to be specific, determine the to-be-marginalized state vector in the pose vector and the landmark characteristic vector by using a sliding window method or a parallax method.

S605: Linearize the nonlinearized constraint equation established in S603, to be specific, calculate Jacobian matrices of the motion equation and the observation equation in S603, and linearize the nonlinearized constraint equation in S603 based on the Jacobian matrices to obtain a first linearized constraint equation.

S606: Rearrange the linearized constraint equation established in S605, and separate the to-be-marginalized state vector from other state vectors in the linearized constraint equation, to be specific, rearrange, based on the to-be-marginalized state vector determined in S604, the first linearized constraint equation established in S605, and separate a to-be-preserved state vector in the first linearized constraint equation from the to-be-marginalized state vector in the first linearized constraint equation.

S607: Calculate a left null space of a Jacobian matrix of the to-be-marginalized state vector, to be specific, calculate the left null space of the to-be-marginalized state vector based on a rearranged first linearized constraint equation obtained in S606.

S608: Marginalize the state vector, and determine a reduced linearized constraint equation, to be specific, left-multiply the left null space of the to-be-marginalized state vector obtained through calculation in S607, by the rearranged first linearized constraint equation obtained in S606, to obtain a reduced second linearized constraint equation.

S609: Construct an objective function based on the reduced second linearized constraint equation determined in S608, and calculate a marginalized information matrix.

S610: Perform graph optimization on the objective function, and construct, based on the information matrix obtained in S609, a prior constraint for next optimization.

S611: If a SLAM process ends, output a track of the intelligent device and a map of an environment in which the intelligent device is located; or if a SLAM process does not end, perform steps S601 to S610 cyclically.

Table 1 shows a calculation time comparison between a Schur complement based marginalization method and a null-space based marginalization method according to an embodiment of this application. It can be learned from Table 1 that running efficiency of the null-space based marginalization method is 4.6 times that of the Schur complement based marginalization method.

TABLE 1

| Marginalization algorithm | Average running time (s) |
|---|---|
| Schur complement based | 0.0440574 |
| marginalization algorithm | |
| Null-space based | 0.00953969 |
| marginalization algorithm | |

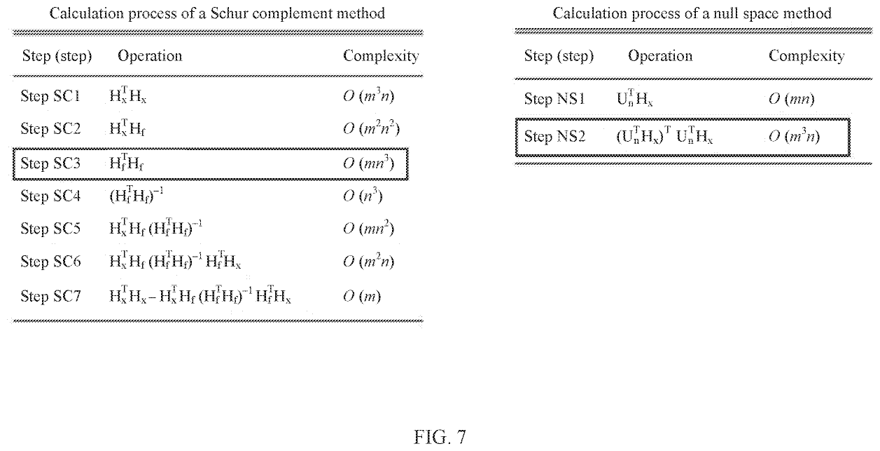

FIG. 7 shows a calculation step comparison between a null space method according to an embodiment of this application and a Schur complement method. As shown in FIG. 7, calculation complexity of the two methods is compared and analyzed. It is assumed that n landmark characteristics are tracked for m robot poses. Black boxes represent steps that are most time consuming in the two marginalization methods. Usually, n is much greater than m. It can be learned that calculation complexity of the null space method is less than that of the Schur complement method.

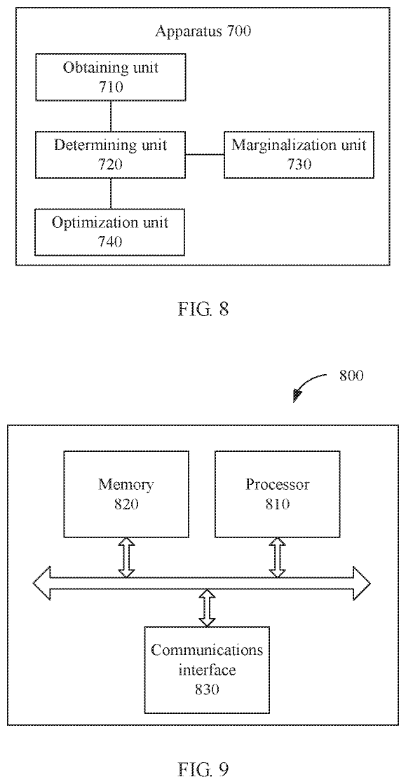

The foregoing describes the data processing methods in the embodiments of this application in detail with reference to FIG. 2 to FIG. 7. The following describes data processing apparatuses in embodiments of this application with reference to FIG. 8 and FIG. 9.

FIG. 8 is a schematic block diagram of a data processing apparatus 700 according to an embodiment of this application. As shown in FIG. 8, the apparatus 700 includes:

an obtaining unit 710, configured to obtain a state vector set of an intelligent device, where the state vector set includes at least one pose vector of the intelligent device and/or at least one landmark characteristic vector of an environment in which the intelligent device is located, and the at least one pose vector and/or the at least one landmark characteristic vector are/is used to locate the intelligent device and map the environment in which the intelligent device is located;

a determining unit 720, configured to determine a first linearized constraint equation, where the first linearized constraint equation represents a linearized constraint relationship between the at least one pose vector and/or the at least one landmark characteristic vector, where

the determining unit 720 is further configured to determine a first state vector, where the first state vector is a to-be-marginalized state vector in the state vector set;

a marginalization unit 730, configured to marginalize the first state vector in the first linearized constraint equation to obtain a second linearized constraint equation, where the second linearized constraint equation represents a linearized constraint relationship of second state vectors, and the second state vector is a state vector other than the first state vector e state vector set, where

the determining unit 720 is further configured to determine an objective function for maximum likelihood estimation of the state vector based on the second linearized constraint equation; and

an optimization unit 740, configured to optimize the at least one pose vector and/or the at least one landmark characteristic vector based on the objective function, to output a track of the intelligent device and a map of the environment in which the intelligent device is located.

Optionally, the marginalization unit 730 is specifically configured to:

marginalize the first state vector in the first linearized constraint equation based on a null space of a Jacobian matrix of the first state vector, to obtain the second linearized constraint equation.

Optionally, the marginalization unit is specifically configured to:

determine the Jacobian matrix of the first state vector;

determine a left null space of the Jacobian matrix of the first state vector based on the Jacobian matrix of the first state vector; and

left-multiply the left null space of the Jacobian matrix of the first state vector by the first linearized constraint equation to obtain the second linearized constraint equation.

Optionally, the second linearized constraint equation is:

Uₘ^{T}\tilde{z}≈Uₘ^{T}Hᵤ\tilde{x}ᵤ+Uₘ^{T}n, where

\tilde{x}ᵤ is an error vector of the second state vector, Hᵤ is a Jacobian matrix of the second state vector, Uₘ is the null space of the Jacobian matrix of the first state vector, \tilde{z} is a residual vector of an observed vector, and n is a white Gaussian noise vector.

Optionally, the apparatus 700 further includes:

a rearrangement unit, configured to rearrange the first linearized constraint equation based on the first state vector, where the first state vector in the rearranged first linearized constraint equation is separated from the second state vector in the rearranged first linearized constraint equation.

Optionally, the rearranged first linearized constraint equation is:

\tilde{z}≈Hᵤ\tilde{x}ᵤ+Hₘ\tilde{x}ₘ+n, where

\tilde{x}ᵤ is the error vector of the second state vector, xₘ is an error vector of the first state vector, Hₘ is the Jacobian matrix of the first state vector, Hᵤ is the Jacobian matrix of the second state vector, \tilde{z} is the residual vector of the observed vector, and n is the white Gaussian noise vector.

Optionally, the determining unit 720 is further configured to:

determine an information matrix based on the objective function, where the information matrix is a constraint for next data processing.

Optionally, the determining unit is further configured to:

determine a nonlinearized constraint equation of the at least one pose vector anchor the at least one landmark characteristic vector; and

linearize the nonlinearized constraint equation based on a Jacobian matrix of the at least one pose vector and/or the at least one landmark characteristic vector, to obtain the first linearized constraint equation.

Optionally, the determining unit 720 is further configured to:

determine an information matrix based on the objective function, where the information matrix is used to optimize and update the second state vector; and construct a new constraint term based on the optimized and updated second state vector, where the constraint term is used to constrain a linearized constraint equation established during next data processing.

It should be understood that the data processing apparatus 700 may correspond to the SLAM system in the data processing method 200 in the embodiment of this application. The data processing apparatus 700 may include modules configured to perform the method performed by the SLAM system in the data processing method 200 in FIG. 2. Moreover, the modules in the data processing apparatus 700 and the foregoing and other operations and/or functions are respectively used for implementing corresponding procedures in the data processing method 200 in FIG. 2. Specifically, the obtaining unit 710 is configured to perform step 210 in the method 200; the determining unit 720 is configured to perform steps 220, 230, and 250 in the method 200; the marginalization unit 730 is configured to perform step 240 in the method 200; and the optimization unit 740 is configured to perform step 260 in the method 200. Specific processes of performing the corresponding steps by the units are already described in detail in the method 200. For brevity, details are not described herein again.

FIG. 9 is a schematic structural diagram of a data processing apparatus 800 according to an embodiment of this application. As shown in FIG. 9, the data processing apparatus 800 includes a processor 810, a memory 820, and a communications interface 830. The memory 820 stores an instruction, and the processor 810 is configured to execute the instruction in the memory 820. When the instruction is executed, the processor 810 is configured to perform the method provided in the foregoing method embodiment The processor 810 is further configured to control the communications interface 830 to communicate with the outside.

Specifically, the data processing apparatus 800 may correspond to the SLAM system 100 according to the embodiments of this application. The data processing apparatus 800 may include modules configured to perform the method performed by the SLAM system 100 in the data processing method 200 in FIG. 2. Moreover, the modules in the data processing apparatus 800 and the foregoing and other operations and/or functions are respectively used for implementing corresponding procedures in the data processing method 200 in FIG. 2. Specific processes of performing the corresponding steps by the modules are described in detail in the method 200. For brevity, details are not described herein again.

An embodiment of this application further provides a computer readable storage medium. The computer readable storage medium includes a computer program. When the computer program is run on a computer, the computer is enabled to perform the method provided in the foregoing method embodiment.

An embodiment of this application further provides a computer program product including an instruction. When the computer program product is run on a computer, the computer is enabled to perform the method provided in the foregoing method embodiment.

It should be understood that the processor in the embodiments of this application may be a central processing unit (CPU), or the processor may be another general purpose processor, a digital signal processor (DSP), an application-specific integrated circuit (ASIC), a field programmable gate array (FPGA) or another programmable logic device, a discrete gate or a transistor logic device, a discrete hardware component, or the like. The general purpose processor may be a microprocessor, or the processor may be any conventional processor or the like.

It should b further understood that the memory in the embodiments of this application may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. By way of example rather than limitation, many forms of random access memories (RAM) may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

A person of ordinary skill in the art may be aware that units and algorithm steps in examples described with reference to the embodiments disclosed in this specification can be implemented by electronic hardware or a combination of computer software and electronic hardware. Whether the functions are performed by hardware or software depends on particular applications and design constraints of the technical solutions. A person skilled in the art may use a different method to implement the described functions for each particular application, but it should not be considered that the implementation goes beyond the scope of this application.

It may be clearly understood by a person skilled in the art that, for the purpose of ease and brevity of description, for detailed working processes of the foregoing system, apparatus, and unit, refer to corresponding processes in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or may be integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to actual requirements, to achieve the objectives of the solutions in the embodiments.

In addition, functional units in the embodiments of this application may be integrated into one processing unit, or each of the units may exist alone physically, or two or more units may be integrated into one unit.

When the functions are implemented in a form of a software functional unit and sold or used as an independent product, the functions may be stored in a computer readable storage medium. Based on such an understanding, the technical solutions of this application essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A data processing method, comprising:
obtaining a state vector set of an intelligent device, wherein the state vector set comprises at least one of at least one pose vector of the intelligent device or at least one landmark characteristic vector of an environment in which the intelligent device is located, and wherein the at least one of the at least one pose vector or the at least one landmark characteristic vector is used to locate the intelligent device and map the environment in which the intelligent device is located;
determining a first linearized constraint equation, wherein the first linearized constraint equation represents a linearized constraint relationship between the at least one of the at least one pose vector or the at least one landmark characteristic vector;
determining a first state vector, wherein the first state vector is a to-be-marginalized state vector in the state vector set;
marginalizing the first state vector in the first linearized constraint equation to obtain a second linearized constraint equation, wherein the second linearized constraint equation represents a linearized constraint relationship of second state vectors, and wherein the second state vector is a state vector other than the first state vector in the state vector set;
determining an objective function for maximum likelihood estimation of the state vector based on the second linearized constraint equation; and
optimizing the at least one of the at least one pose vector or the at least one landmark characteristic vector based on the objective function to output a track of the intelligent device and a map of the environment in which the intelligent device is located.

2. The method according to claim 1, wherein the marginalizing the first state vector in the first linearized constraint equation to obtain a second linearized constraint equation comprises:
marginalizing the first state vector in the first linearized constraint equation based on a null space of a Jacobian matrix of the first state vector to obtain the second linearized constraint equation.

3. The method according to claim 2, wherein the marginalizing the first state vector in the first linearized constraint equation based on a null space of a Jacobian matrix of the first state vector to obtain the second linearized constraint equation comprises:
determining the Jacobian matrix of the first state vector;
determining a left null space of the Jacobian matrix of the first state vector based on the Jacobian matrix of the first state vector; and
left-multiplying the left null space of the Jacobian matrix of the first state vector by the first linearized constraint equation to obtain the second linearized constraint equation.

4. The method according to claim 2, wherein the second linearized constraint equation is:
Uₘ^{T}\tilde{z}≈Uₘ^{T}Hᵤ\tilde{x}ᵤ+Uₘ^{T}n, wherein
\tilde{x}ᵤ is an error vector of the second state vector, Hᵤ is a Jacobian matrix of the second state vector, Uₘ is the null space of the Jacobian matrix of the first state vector, \tilde{z} is a residual vector of an observed vector, and n is a white Gaussian noise vector.

5. The method according to claim 1, wherein before the marginalizing the first state vector in the first linearized constraint equation to obtain a second linearized constraint equation, the method further comprises:
rearranging the first linearized constraint equation based on the first state vector, wherein the first state vector in the rearranged first linearized constraint equation is separated from the second state vector in the rearranged first linearized constraint equation.

6. The method according to claim 5, wherein the rearranged first linearized constraint equation is:
\tilde{z}≈Hᵤ\tilde{x}ᵤ+Hₘ\tilde{x}ₘ+n, wherein
\tilde{x}ᵤ is an error vector of the second state vector, \tilde{x}ₘ is an error vector of the first state vector, Hₘ is a Jacobian matrix of the first state vector, Hᵤ is a Jacobian matrix of the second state vector, \tilde{z} is a residual vector of an observed vector, and n is a white Gaussian noise vector.

7. The method according to claim 1, wherein before the determining a first linearized constraint equation, the method further comprises:
determining a nonlinearized constraint equation of the at least one of the at least one pose vector or the at least one landmark characteristic vector; and
linearizing the nonlinearized constraint equation based on a Jacobian matrix of the at least one of the at least one pose vector or the at least one landmark characteristic vector, to obtain the first linearized constraint equation.

8. A data processing device, comprising at least one processor and a non-transitory medium storing program instructions, wherein the at least one processor, by executing the program instructions, causes the data processing device to:
obtain a state vector set of an intelligent device, wherein the state vector set comprises at least one of at least one pose vector of the intelligent device or at least one landmark characteristic vector of an environment in which the intelligent device is located, and wherein the at least one of the at least one pose vector or the at least one landmark characteristic vector is used to locate the intelligent device and map the environment in which the intelligent device is located;
determine a first linearized constraint equation, wherein the first linearized constraint equation represents a linearized constraint relationship between the at least one of the at least one pose vector or the at least one landmark characteristic vector;
determine a first state vector, wherein the first state vector is a to-be-marginalized state vector in the state vector set;
marginalize the first state vector in the first linearized constraint equation to obtain a second linearized constraint equation, wherein the second linearized constraint equation represents a linearized constraint relationship of second state vectors, and wherein the second state vector is a state vector other than the first state vector in the state vector set;
determine an objective function for maximum likelihood estimation of the state vector based on the second linearized constraint equation; and
optimize the at least one of the at least one pose vector or the at least one landmark characteristic vector based on the objective function to output a track of the intelligent device and a map of the environment in which the intelligent device is located.

9. The data processing device according to claim 8, wherein the at least one processor is configured to marginalize the first state vector in the first linearized constraint equation based on a null space of a Jacobian matrix of the first state vector to obtain the second linearized constraint equation.

10. The data processing device according to claim 9, wherein the at least one processor is configured to:
determine the Jacobian matrix of the first state vector;
determine a left null space of the Jacobian matrix of the first state vector based on the Jacobian matrix of the first state vector; and
left-multiply the left null space of the Jacobian matrix of the first state vector by the first linearized constraint equation to obtain the second linearized constraint equation.

11. The data processing device according to claim 9, wherein the second linearized constraint equation is:
Uₘ^{T}\tilde{z}≈Uₘ^{T}Hᵤ\tilde{x}ᵤ+Uₘ^{T}n, wherein
\tilde{x}ᵤ is an error vector of the second state vector, Hᵤ is a Jacobian matrix of the second state vector, Uₘ is the null space of the Jacobian matrix of the first state vector, \tilde{z} is a residual vector of an observed vector, and n is a white Gaussian noise vector.

12. The data processing device according to claim 8, wherein the at least one processor, by executing the program instructions, further causes the device to: rearrange the first linearized constraint equation based on the first state vector, wherein the first state vector in the rearranged first linearized constraint equation is separated from the second state vector in the rearranged first linearized constraint equation.

13. The data processing device according to claim 12, wherein the rearranged first linearized constraint equation is:
\tilde{z}≈Hᵤ\tilde{x}ᵤ+Hₘ\tilde{x}ₘ+n, wherein
\tilde{x}ᵤ is an error vector of the second state vector, \tilde{x}^{m} is an error vector of the first state vector, Hₘ is a Jacobian matrix of the first state vector, Hᵤ is a Jacobian matrix of the second state vector, \tilde{z} is a residual vector of an observed vector, and n is a white Gaussian noise vector.

14. The data processing device according to claim 8, wherein the at least one processor, by executing the program instructions, further causes the device to:
determine a nonlinearized constraint equation of the at least one of the at least one pose vector or the at least one landmark characteristic vector; and
linearize the nonlinearized constraint equation based on a Jacobian matrix of the at least one of the at least one pose vector or the at least one landmark characteristic vector, to obtain the first linearized constraint equation.

15. A non-transitory computer readable storage medium comprising a computer program which, when executed by a computer, cause the computer to perform operations comprising:
obtaining a state vector set of an intelligent device, wherein the state vector set comprises at least one of at least one pose vector of the intelligent device or at least one landmark characteristic vector of an environment in which the intelligent device is located, and wherein the at least one of the at least one pose vector or the at least one landmark characteristic vector is used to locate the intelligent device and map the environment in which the intelligent device is located;
determining a first linearized constraint equation, wherein the first linearized constraint equation represents a linearized constraint relationship between the at least one of the at least one pose vector or the at least one landmark characteristic vector;
determining a first state vector, wherein the first state vector is a to-be-marginalized state vector in the state vector set;
marginalizing the first state vector in the first linearized constraint equation to obtain a second linearized constraint equation, wherein the second linearized constraint equation represents a linearized constraint relationship of second state vectors, and wherein the second state vector is a state vector other than the first state vector in the state vector set;
determining an objective function for maximum likelihood estimation of the state vector based on the second linearized constraint equation; and
optimizing the at least one of the at least one pose vector or the at least one landmark characteristic vector based on the objective function to output a track of the intelligent device and a map of the environment in which the intelligent device is located.
